(19) United States
(12) Patent Application Publication
(10) Pub. No.: US 2025/0106343 A1
(43) Pub. Date: Mar. 27, 2025

(54) SCANNER GENERATING SPLIT IMAGE FILES INCLUDING TRANSMITTING AND VISIBLE LIGHT INFORMATION

(71) Applicant: AVISION INC., Hsinchu (TW)

(72) Inventors: Yen-Cheng CHEN, Hsinchu County (TW); Chun-Chieh LIAO, Hsinchu City (TW)

(21) Appl. No.: 18/795,949

(22) Filed: Aug. 6, 2024

(30) Foreign Application Priority Data
Sep. 22, 2023 (TW) 112136163

(51) Int. Cl. H04N 1/387

(52) U.S. Cl. CPC H04N 1/3878; H04N 1/3872

(57) ABSTRACT

A scanner includes a scanning module, a processor and an output port. The scanning module scans a document to generate a first signal representative of a composite visible light image of the document and a background element, and a second signal representative of a transmitting light image transmitting through the document. The processor generates a first final image file having first pixels and first complementary pixels according to the first signal, and generates a second final image file having second pixels and second complementary pixels according to the second signal. The first pixels are representative of a visible light image of the document. The first complementary pixels are representative of a remaining visible light image other than the document. The second pixels are representative of a transmitting light image of the document. The second complementary pixels are representative of a remaining transmitting light image other than the document. The output port outputs the first and second final image files to an external device.

### CROSS-REFERENCE TO RELATED APPLICATIONS

This application claims priority of No. 112136163 filed in Taiwan R.O.C. on Sep. 22, 2023 under 35 USC 119, the entire content of which is hereby incorporated by reference.

### FIELD OF THE INVENTION

This disclosure relates to a scanner, and more particularly to a scanner for generating split image files including transmitting and visible light information.

### DESCRIPTION OF RELATED ART

After a conventional scanner has scanned a document having a hole, the obtained visible light image has a totally black hole image at a position corresponding to the hole. If a user wants to print out the visible light image, a lot of toner is wasted in printing the totally black hole image. At present, copiers on the market directly print out the totally black hole image. Although the hole image can be removed using image processing software, such post-processing is not accurate, occupies a lot of performance, wastes the user's time, and is a hindrance to users unfamiliar with computers.

On the other hand, a preview scan can be performed to set the boundaries to be cropped and prevent the hole or damaged portion from being formally scanned. However, if the information around the hole is not scanned, the scan is not complete, and such the operation method is also very complicated. In addition, due to the restriction of the optical principle, shadows will be present at locations corresponding to edges of the document upon document scanning, complicated post-processing is needed to precisely remove the shadows, or the shadows cannot be easily removed. The easy way is to process the image by way of frame cropping. However, the shadows sometimes cannot be correctly removed.

As the development of computer software advances day by day, the user can drag one image across different backgrounds to render the blending effects of different backgrounds with the image. Therefore, how to correctly determine the contour of the original for the further application is indeed a problem to be solved by this disclosure.

### SUMMARY OF THE INVENTION

It is therefore an objective of this disclosure to provide a scanner generating split image files including transmitting and visible light information to be immediately outputted to an external device.

To achieve the above-identified objective, this disclosure provides a scanner including a scanning module, a processor and an output port. The scanning module scans a document to generate a first signal and a second signal. The first signal is representative of a composite visible light image of the document and a background element. The second signal is representative of a transmitting light image transmitting through the document. The processor electrically connected to the scanning module generates a first final image file having first pixels and first complementary pixels according to the first signal, and generates a second final image file having second pixels and second complementary pixels according to the second signal. The first pixels and the first complementary pixels are arranged in a rectangular array. The second pixels and the second complementary pixels are arranged in the rectangular array. The first pixels are representative of a visible light image of the document, and the first complementary pixels are representative of a remaining visible light image other than the document. The second pixels are representative of a transmitting light image of the document, and the second complementary pixels are representative of a remaining transmitting light image other than the document. The output port electrically connected to the processor outputs the first final image file and the second final image file to an external device.

With the above-mentioned embodiment, the scanner can be used to directly obtain split image files including transmitting and visible light information, and the generated file may have a portable document format (PDF) or other file formats. The external device and/or scanner can generate the image that truly represents the contour information and visible light information of the document according to the visible light and transmitting light information of the split image files, so that the non-physical part of the document and the part other than the document can represent the color of the background with the change of the color of the background, and the original contour of the document can be present. On the other hand, the shadow of the document may also be further removed, so that the original contour of the document can be present without distortion.

In order to make the above-mentioned content of this disclosure more obvious and be easily understood, preferred embodiments will be described in detail as follows in conjunction with the accompanying drawings.

### BRIEF DESCRIPTION OF DRAWINGS

FIG. 1 is a schematic view showing a scanner according to a preferred embodiment of this disclosure.

FIG. 2 is a schematic view showing a first final image file outputted from the scanner of FIG. 1.

FIG. 3 is a schematic view showing a second final image file outputted from the scanner of FIG. 1.

FIG. 4 shows an example of channel values of original pixels classified and processed into a combination of a first pixel and a second pixel and a combination of a first complementary pixel and a second complementary pixel.

FIG. 5 is a schematic view showing another example of the first final image file outputted from the scanner of FIG. 1.

FIG. 6 is a flow chart showing steps performed by a processor of FIG. 1.

FIG. 7 is a schematic view showing an example of obtaining third and fourth final image files according to a composite visible light image and a transmitting light image.

### DETAILED DESCRIPTION OF THE INVENTION

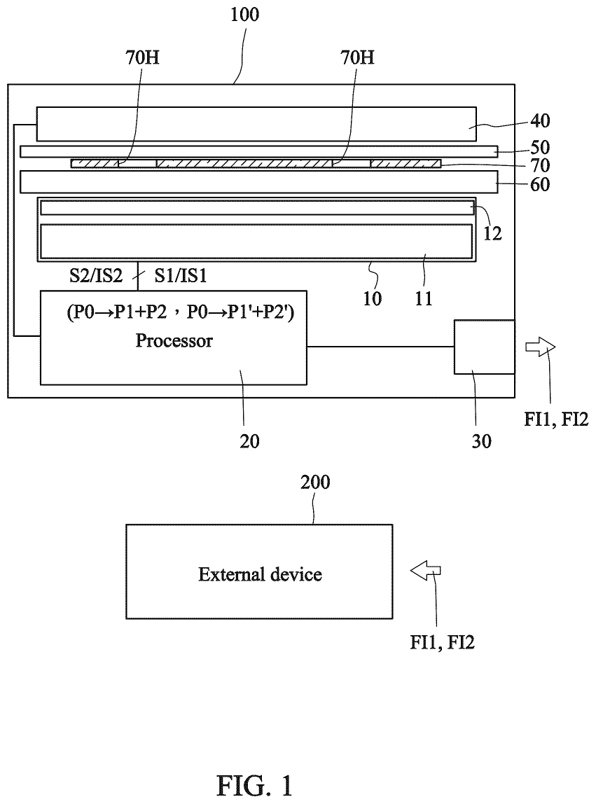

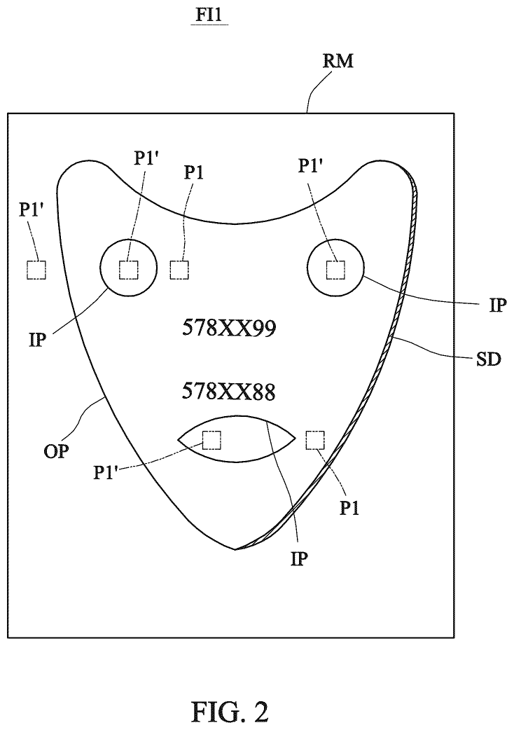

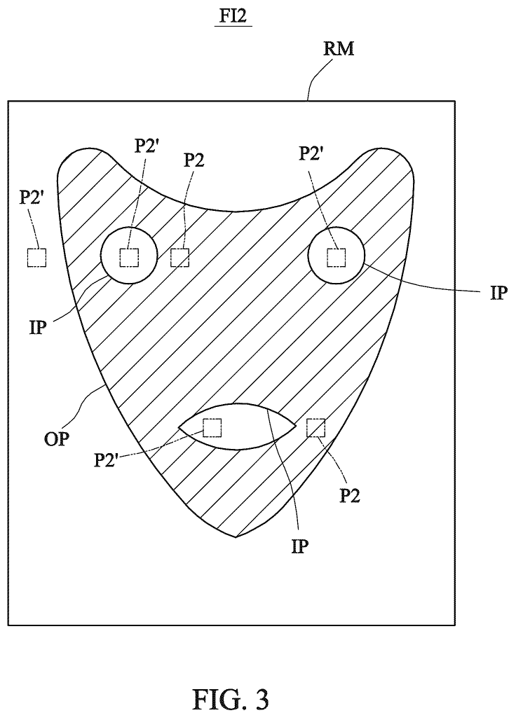

FIG. 1 is a schematic view showing a scanner 100 according to a preferred embodiment of this disclosure. FIGS. 2 and 3 are schematic views respectively showing a first final image file and a second final image file outputted from the scanner 100 of FIG. 1. Referring to FIGS. 1 to 3, the scanner 100 includes a scanning module 10, a processor 20 and an output port 30. The scanner 100 may be a document scanner or a multi-function peripheral.

The scanning module 10 scans a document 70 to generate a first signal S1 and a second signal S2. In one example, a visible light source 12 of the scanning module 10 is disposed below a transparent platen 60, and outputs visible light reflected, by a physical part of the document 70 and a background element 50, back to an image sensor 11 of the scanning module 10, such as a contact image sensor (CIS) or a charge-coupled device (CCD) image sensor. Therefore, the first signal S1 is representative of a composite visible light image IS1 of the document 70 and the background element 50, and is also representative of visible light channel values of original pixels P0. On the other hand, a transmitting light source 40 (e.g., infrared light source) of the scanning module 10 is disposed above the background element 50 and the document 70, the infrared light outputted from the infrared light source may transmit through the background element 50, and transmit through a hole 70H of the document 70 and portions other than (or outside) edges of the document 70. That is, the infrared light cannot transmit through the physical part (may also be defined as a part having a predetermined thickness) of the document 70. Therefore, the second signal S2 is representative of a transmitting light image IS2 transmitting through the document 70, and may also be representative of the transmitting light image IS2 obtained after the transmitting light transmits through the document 70 and the background element 50. That is, the second signal S2 is representative of transmitting light channel values of the original pixels P0. In addition, the background element 50 may serve as a standard-white calibration reference of the image sensor 11.

The processor 20 electrically connected to the scanning module 10 generates a first final image file FI1 having first pixels P1 and first complementary pixels P1′ according to the first signal S1, and generates a second final image file FI2 having second pixels P2 and second complementary pixels P2′ according to the second signal S2. The first pixels P1 and the first complementary pixels P1′ are arranged in a rectangular array RM, and are arranged at complementary positions. Similarly, the second pixels P2 and the second complementary pixels P2′ are arranged in the rectangular array RM, and are arranged at complementary positions. The first pixels P1 representative of a visible light image of the document 70, which is the reflected light image formed by the light reflected from the physical part of the document 70 and may include a shadow image SD. The first complementary pixels P1′ is representative of a remaining visible light image (the image parts outside an outer contour OP and inside an inner contour IP) other than the document 70. The image inside the inner contour IP is representative of the non-physical part (e.g., the hole or damaged part) of the document. The second pixels P2 are representative of the transmitting light image of the document 70, and the second complementary pixels P2′ are representative of a remaining transmitting light image other than the document 70. In one example, the first and second final image files have information such as headers, footers and the like.

The output port 30 electrically connected to the processor 20 outputs the first final image file FI1 and the second final image file FI2 to an external device 200. The output port 30 includes, for example but without limitation to, a wired network connection port, a wireless network connection port, a universal serial bus (USB) connection port and the like. The first final image file FI1 and the second final image file FI2 may be outputted as individual files, and may also be integrated into and outputted as a multi-layer file.

With the above-mentioned scanner 100, the signal obtained by optical scanning can be utilized to directly and quickly generate and output the image having the visible light channel values and transmittance, and to precisely obtain the boundary and position of the hole of the document 70, so that the scanner and/or the external device can precisely eliminate the shadow.

In this embodiment, the scanning module 10 performs one-time scanning on the document 70 to generate the first signal S1 and the second signal S2 to achieve the time-saving effect. In another example, the scanning module 10 can perform multiple times of scanning on the document 70 to generate the signal, but the invention is not restricted thereto. In FIG. 2, the first final image file FI1 includes the shadow image SD. This is because the document has a certain thickness, and the visible light of the scanning module is slantingly emitted to the document to obtain the reflected light. With the second final image file FI2 serving as the reference, the external device or scanner can obtain the contour information of the document and perform subsequent processing to effectively remove the shadow image SD or disable the shadow image SD from being present. In the above-mentioned example, only one single scanning module 10 is used to perform scanning, and then the composite visible light image IS1 and the transmitting light image IS2 (or the first final image file FI1 and the second final image file FI2) are processed into two image files or a multi-layer image file (e.g., multi-layered PDF file), and the output port 30 outputs the split image files or the multi-layer image file to be further processed by the external device. Therefore, the shadow image SD in the rectangular array RM is not further processed, so that positions of the first pixels P1 are not completely the same as positions of the second complementary pixels P2′, and positions of the second pixels P2 are not completely the same as positions of the first complementary pixels P1′.

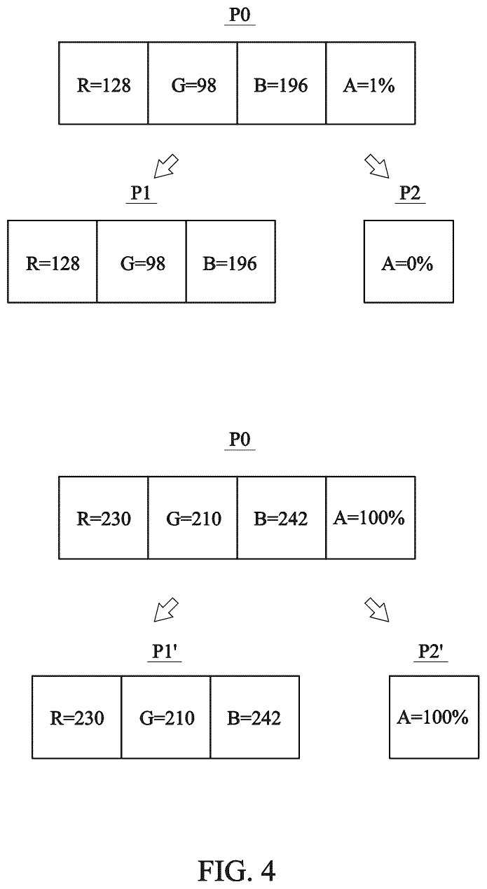

FIG. 4 shows an example of channel values of original pixels P0 classified and processed into a combination of the first pixel P1 and the second pixel P2 and a combination of the first complementary pixel P1′ and the second complementary pixel P2′. Referring to FIG. 4, one original pixel P0 has a red channel value (R=128), a green channel value (G=98), a blue channel value (B=196) and a transmitting light channel value (A=1%). After being processed by the processor 20 of FIG. 1, the original pixel P0 is determined as being representative of the physical part of the document according to the transmitting light channel value (A=1%); the visible light image thereof pertains to the first pixel P1, so the red, green and blue channel values are kept; and the transmitting light image pertains to the second pixel P2, so the transmitting light channel value (A=1%) is set as (A=0%). That is, the second pixel P2 is representative of or has a transmittance equal to 0%, so that the first pixel P1 and the second pixel P2 have the channel values shown in FIG. 4. Of course, the transmitting light channel value (A=1%) may also be kept in another example.

Another original pixel P0 has the red channel value (R=230), the green channel value (G=210), the blue channel value (B=242) and the transmitting light channel value (A=100%). After being processed by the processor 20 of FIG. 1, the original pixel P0 is determined as being representative of the non-physical part of the document or the part other than the document according to the transmitting light channel value (A=100%); the visible light image thereof pertains to the first complementary pixel P1′, so the red, green and blue channel values are kept; and the transmitting light image thereof pertains to the second complementary pixel P2′, so the transmitting light channel value (A=100%) is kept as (A=100%). So, the first complementary pixel P1′ and the second complementary pixel P2′ have the channel values shown in FIG. 4. In another example, the red, green and blue channel values of the first complementary pixel P1′ may also be set as 0 because the transmitting light channel value corresponding to the second complementary pixel P2′ has disabled the red, green and blue channel values of the first complementary pixel P1′ from being present. It is understandable that the red, green and blue channel values may correspond to the visible light channel values in the application of the black-and-white scanning module. Therefore, the first signal S1 and the second signal S2 are representative of visible light channel values and transmitting light channel values of the original pixels P0. In another example, R, G, B may also be converted into the luminance Y, the red-difference chroma Cr and the blue-difference chroma Cb. Therefore, the original pixel P0 can be precisely classified, according to the transmitting light channel value, into the combination of the first pixel P1 and the second pixel P2, or the combination of the first complementary pixel P1′ and the second complementary pixel P2′.

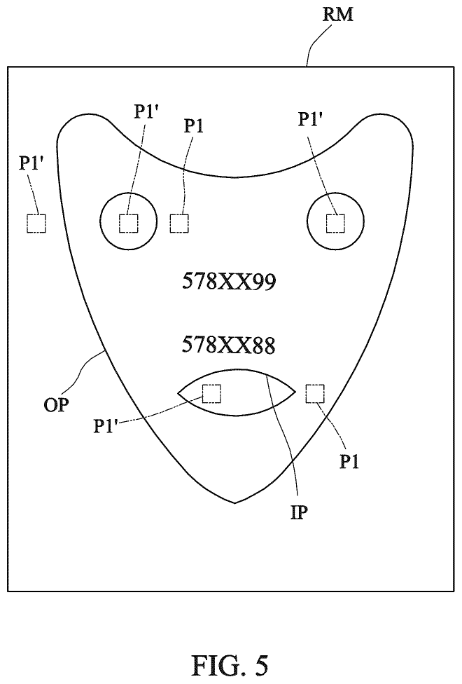

FIG. 5 is a schematic view showing another example of the first final image file outputted from the scanner of FIG. 1, wherein the second final image file is shown in FIG. 3. Referring to FIGS. 5 and 3, this example is similar to FIG. 2 except for the difference that the processor can further process the composite visible light image IS1 and the transmitting light image IS2, and the shadow image SD has been removed. That is, the set of the first pixels P1 do not have the part of the shadow image SD, and the removed part of the shadow image SD falls within the range of the set of the second pixels P2. Therefore, in the rectangular array RM, the positions of the first pixels P1 are completely the same as the positions of the second complementary pixels P2′, and the positions of the second pixels P2 are completely the same as the positions of the first complementary pixels P1′. The advantages of this example reside in that the external device does not need to perform the shadow removing process. In addition, if the contour definition has problems, debugging can start from the scanner 100, but not from the external device 200. It is understandable that the scanner 100 may output: (a) final image files representative of FIGS. 2 and 3; and/or (b) final image files representative of FIGS. 5 and 3 to satisfy different applications and provide diversified options for the user. In one example, the processor may perform image processing to make the second complementary pixels P2′ be representative of or have a transmittance greater than 0%, and make the second pixels P2 be representative of or have a transmittance equal to 0%. For example, the transmittance of the second complementary pixels P2′ may be set to 100%. Consequently, no matter what the visible light image of the first pixels P1 is, the visible light image changes with the background according to the transmittance of 100%.

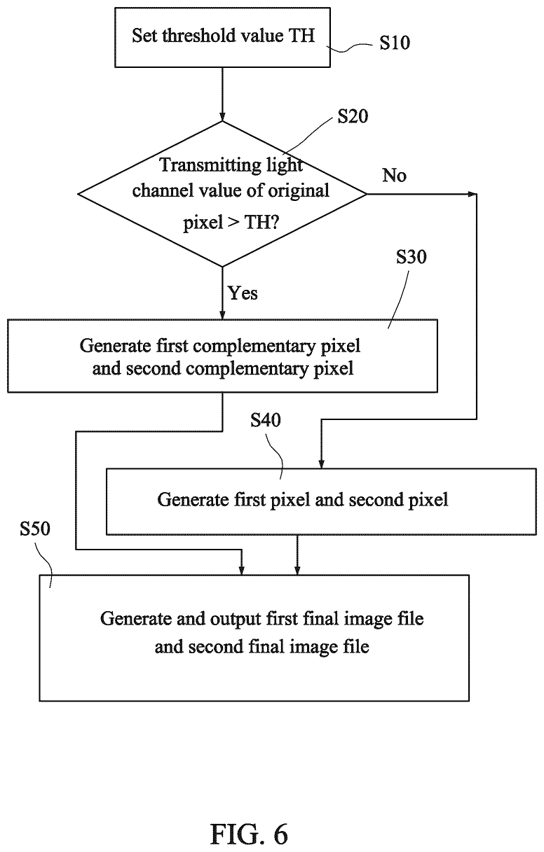

FIG. 6 is a flow chart showing steps performed by the processor of FIG. 1. Referring to FIGS. 6 and 1, the processor 20 performs the following steps S10, S20, S30, S40 and S50. In the step S10, a threshold value TH is set by receiving a user's input or selecting one of values from a database according to different states, or is set as a default value. In the step S20, it is judged whether the transmitting light channel value (e.g., fourth channel value) of each original pixel P0 is greater than the threshold value TH or not. If yes, the step S30 is entered to generate the first complementary pixel P1′ and the second complementary pixel P2′, wherein the first complementary pixel P1′ has the visible light channel value, and the second complementary pixel P2′ has the original transmitting light channel value or adjusted transmitting light channel value, such as 100%. If not, the step S40 is entered to generate the first pixel P1 and the second pixel P2, wherein the first pixel P1 has the visible light channel value, and the second pixel P2 has the original transmitting light channel value or adjusted transmitting light channel value, such as 0%. Finally, in the step S50, the first pixels P1 and the first complementary pixels P1′ are combined into the first final image file, and the second pixels P2 and the second complementary pixels P2′ are combined into the second final image file. Next, the first final image file and the second final image file may be outputted as split files. It is understandable that it is unnecessary to set the transmitting light channel value as 100% because the original transmitting light channel value may also be kept so that the external device 200 can have further applications. For example, the external device 200 may judge the crease of the document (the thickness is small, and the transmittance thereof differs from that of each of other parts) or the posted part of the document according to the transmitting light channel value. Of course, the processor 20 may also judge the crease of the document or the posted part of the document.

The above-mentioned processing and judging methods are very simple, and thus do not need the high-end processor and the large-capacity memory, so the cost is further decreased.

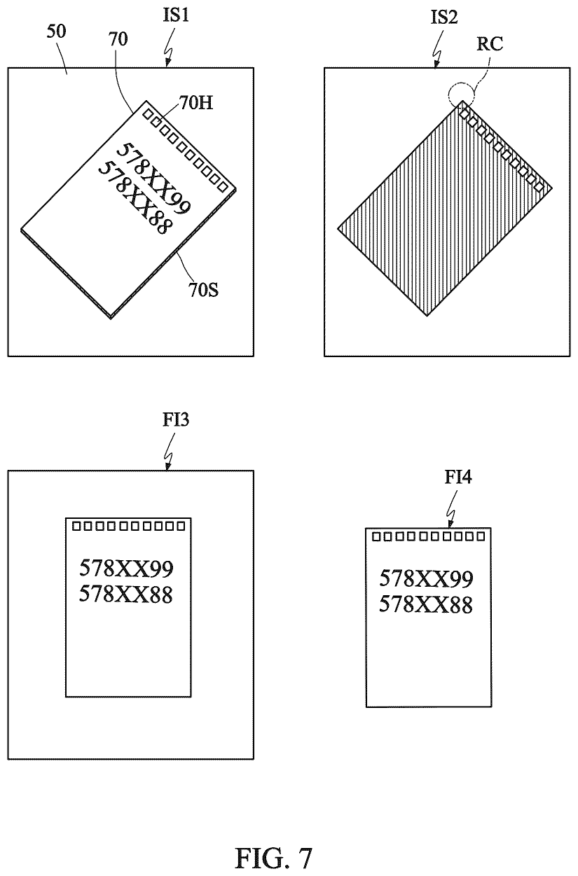

FIG. 7 is a schematic view showing an example of obtaining third and fourth final image files according to the composite visible light image and the transmitting light image. Referring to FIGS. 7 and 1, the processor 20 may further process the composite visible light image IS1 to generate the visible light image according to one or multiple right-angle contour portions RC of the transmitting light image IS2 (equivalent to the second final image file FI2 including the second pixels P2 and the second complementary pixels P2′) represented by the second signal S2, and then perform skew corrections on the visible light image to generate a third final image file FI3, which may be outputted together with the first final image file FI1 and the second final image file FI2. In another example, the first final image file FI1 and the second final image file FI2 may be generated according to the third final image file FI3. The visible light image includes the image representative of the hole 70H of the document 70 and the image of the shadow 70S of the document 70. In this case, the first signal S1 is representative of the composite visible light image IS1 of the document 70, the background element 50 and the shadow 70S and the hole 70H of the document 70. The right-angle contour portion RC may be obtained by looking for the outer boundary corresponding to the document 70, wherein the determination can be made according to the arrangement direction of the pixels representative of the outer boundary. The outer boundary can be easily and precisely obtained according to the transmitting light image IS2. With the above-mentioned embodiment, the shadow of the document can be precisely removed.

In another example, the processor 20 may further perform automatic cropping on the visible light image according to one or multiple right-angle contour portions RC of the transmitting light image IS2 represented by the second signal S2 to obtain a fourth final image file FI4, which may be outputted together with the first final image file FI1 and the second final image file FI2. The first final image file FI1 and the second final image file FI2 may also be generated according to the fourth final image file FI4.

With the scanner of the embodiment, the split image files including transmitting and visible light information can be generated and obtained, the generated file format may be the joint photographic experts group (JPEG) format, the portable network graphics (PNG) format, the PDF format supporting the layering function or any other file format. The external device and/or the scanner can generate the image(s) that truly represent the contour information and visible light information of the document according to the visible light and transmitting light information of the split image files, so that the image parts corresponding to the non-physical part of the document and the part other than the document can be changed to the color of the background with the change of the color of the background. Therefore, the original contour, the hole, damage and the like of the document can be present. On the other hand, the shadow of the document may also be further removed, so that the original contour of the document can be present without distortion.

The specific embodiments proposed in the detailed description of this disclosure are only used to facilitate the description of the technical contents of this disclosure, and do not narrowly limit this disclosure to the above-mentioned embodiments. Various changes of implementations made without departing from the spirit of this disclosure and the scope of the claims are deemed as falling within the following claims.

1. A scanner, comprising:
a scanning module scanning a document to generate a first signal and a second signal, wherein the first signal is representative of a composite visible light image of the document and a background element, and the second signal is representative of a transmitting light image transmitting through the document;
a processor, which is electrically connected to the scanning module, generates a first final image file having first pixels and first complementary pixels according to the first signal, and generates a second final image file having second pixels and second complementary pixels according to the second signal, wherein the first pixels and the first complementary pixels are arranged in a rectangular array, the second pixels and the second complementary pixels are arranged in the rectangular array, the first pixels are representative of a visible light image of the document, the first complementary pixels are representative of a remaining visible light image other than the document, the second pixels are representative of the transmitting light image of the document, and the second complementary pixels are representative of a remaining transmitting light image other than the document; and
an output port, which is electrically connected to the processor, and outputs the first final image file and the second final image file to an external device.

2. The scanner according to claim 1, wherein in the rectangular array, positions of the first pixels are not completely the same as positions of the second complementary pixels, and positions of the second pixels are not completely the same as positions of the first complementary pixels.

3. The scanner according to claim 1, wherein in the rectangular array, positions of the first pixels are completely the same as positions of the second complementary pixels, and positions of the second pixels are completely the same as positions of the first complementary pixels.

4. The scanner according to claim 3, wherein the second complementary pixels has a transmittance greater than 0%, and the second pixels has a transmittance equal to 0%.

5. The scanner according to claim 4, wherein the second complementary pixels has a transmittance equal to 100%.

6. The scanner according to claim 1, wherein the scanning module performs one-time scanning on the document to generate the first signal and the second signal.

7. The scanner according to claim 1, wherein the processor further performs skew corrections on the visible light image according to one or multiple right-angle contour portions of the transmitting light image represented by the second signal.

8. The scanner according to claim 1, wherein the processor further performs automatic cropping on the visible light image according to one or multiple right-angle contour portions of the transmitting light image represented by the second signal.

9. The scanner according to claim 1, wherein the first signal is representative of the composite visible light image of the document, the background element and a shadow of the document.

10. The scanner according to claim 1, wherein the processor further processes the first final image file and the second final image file into a multi-layer image file, and the output port further outputs the multi-layer image file to the external device.
